(19) United States
(12) Patent Application Publication
(10) Pub. No.: US 2009/0300234 A1
(43) Pub. Date: Dec. 3, 2009

(54) BUFFER CONTROL METHOD AND STORAGE APPARATUS

(75) Inventor: Tatsuya Haga, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/388,340

(22) Filed: Feb. 18, 2009

(30) Foreign Application Priority Data
May 28, 2008 (JP) 2008-140121

(51) Int. Cl. G06F 13/00

(52) U.S. Cl. 710/56

(57) ABSTRACT

A buffer control method stores data to be written on a recording medium or data read from the recording medium to consecutive addresses within a storage region of a buffer, based on a sequential access command which instructs a continuous access to consecutive logical addresses of the recording medium, and variably sets a size of the storage region of the buffer depending on an unused region or a used region in the storage region of the buffer. The buffer is used as a buffer ring.

### CROSS-REFERENCE TO RELATED APPLICATIONS

This application is based upon and claims the benefit of priority of the prior Japanese Patent Application No. 2008-140121, filed on May 28, 2008, the entire contents of which are incorporated herein by reference.

### FIELD

The embodiment discussed herein is related to buffer control methods and storage apparatuses.

### BACKGROUND

When a sequential write command which instructs a write operation to consecutive logical addresses on a magnetic disk is issued from a host apparatus with respect to a storage apparatus such as a magnetic disk drive, the magnetic disk drive stores write data at consecutive addresses of a buffer. By storing the write data at the consecutive addresses of the buffer, the write data stored in the buffer can be continuously written on the magnetic disk without having to wait for the rotation of the magnetic disk. When a predetermined amount of consecutive storage regions of the buffer is used, the address which is to store the next data is returned to the address where the data storage started in response to the sequential write command, so that it is possible to continue using the buffer as a buffer ring.

In addition, when a sequential read command which instructs a read operation to consecutive logical addresses on the magnetic disk is issued from the host apparatus with respect to the storage apparatus such as the magnetic disk drive, the magnetic disk drive stores read data read from the consecutive logical addresses on the magnetic disk to consecutive addresses of the buffer, similarly to the sequential write. When a predetermined amount of consecutive storage regions of the buffer is used, the address which is to store the next data is returned to the address where the data storage started in response to the sequential read command, so that it is possible to continue using the buffer as the buffer ring, similarly to the sequential write. However, in the case of the sequential read, the magnetic disk drive continues reading the data from the magnetic disk even after the transfer of the read data to the host apparatus ends, and an operation is performed to continue storing the data from the consecutive logical addresses to the buffer without requiring the issuance of a command.

Conventionally, the storage region of the buffer that is used for the sequential access such as the sequential write and the sequential read has a fixed size. For this reason, when a data transfer associated with the sequential access is made between the host apparatus and the magnetic disk drive, the waiting of the rotation of the magnetic disk occurs due to the generation of a buffer full state at the time of the read or a buffer empty state at the time of the write, depending on a data processing speed of the host apparatus and a data transfer rate of the magnetic disk drive. The buffer full state refers to a state where there is data to be stored in the buffer, such as the read data read from the magnetic disk, but an unused storage region of the buffer is insufficient or there is no unused storage region in the buffer. On the other hand, the buffer empty state refers to a state where there is no data to be read from the buffer, such as the write data to be written on the magnetic disk.

Furthermore, when the buffer empty state at the time of the read or the buffer full state at the time of the write is generated during the waiting of the rotation of the magnetic disk, the magnetic disk drive cannot make a command end response with respect to the host apparatus, to thereby deteriorate the performance of the magnetic disk drive. If the storage region of the buffer used for the sequential access is increased in order to avoid the performance deterioration of the magnetic disk drive, an overwriting will be made on a cache data region of the buffer which holds the cache data. In this case, the amount of cache data that can be held in the cache data region decreases, and as a result, a hit rate to the cache data decreases and the performance of the magnetic disk drive consequently deteriorates.

Various buffer control methods have been proposed in Japanese Laid-Open Patent Publications No. 2000-10898, No. 2006-285809, No. 2001-5724, and No. 2006-139459, for example.

Conventionally, there was a problem in that the performance of the storage apparatus deteriorates when the buffer control is performed at the time of the sequential access.

### SUMMARY

According to one aspect of the present invention, a buffer control method includes storing data to be written on a recording medium or data read from the recording medium to consecutive addresses within a storage region of a buffer, based on a sequential access command which instructs a continuous access to consecutive logical addresses of the recording medium; variably setting a size of the storage region of the buffer depending on an unused region or a used region in the storage region of the buffer; and using the buffer as a buffer ring.

According to another aspect of the present invention, a storage apparatus includes a recording medium; a buffer; and a controller configured to perform a control to store data to be written on the recording medium or data read from the recording medium to consecutive addresses within a storage region of the buffer, based on a sequential access command which instructs a continuous access to consecutive logical addresses of the recording medium, wherein the controller variably sets a size of the storage region of the buffer depending on an unused region or a used region in the storage region of the buffer, and the buffer is used as a buffer ring.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a system in an embodiment of the present invention;

FIG. 2 is a flow chart for explaining an operation of the embodiment;

FIG. 3 is a diagram for explaining an initial setting of a size of a storage region in a data buffer;

FIG. 4 is a diagram for explaining a state where a waiting of a rotation of a magnetic disk is generated in a storage apparatus;

FIG. 5 is a diagram for explaining a resetting of the size of the storage region in the data buffer; and

FIG. 6 is a diagram for explaining the state where the waiting of the rotation of the magnetic disk is generated in the storage apparatus in a case where a conventional technique is employed.

### DESCRIPTION OF EMBODIMENTS

Preferred embodiments of the present invention will be described with reference to the accompanying drawings.

In a buffer control method and a storage apparatus according to one aspect of the present invention, a size of a storage region of a buffer that is used in a sequential access is variably set depending on a state of use of the storage region of the buffer, in order to use the buffer as a buffer ring. Hence, the storage region of the buffer may be set to an optimum storage region where no buffer empty state and no buffer full state is generated.

By determining the size of the storage region of the buffer depending on a data processing speed of a host apparatus or a data transfer rate of a storage apparatus, it is possible to set the storage region of the buffer to a size which is more suited for the host apparatus when compared to the conventional technique. Hence, it is possible to suppress overwriting to a cache data region of the buffer which holds the data, and to suppress generation of the buffer full state and the buffer empty state, in order to suppress the performance deterioration of the storage apparatus. In addition, it is unnecessary to tune the size of the storage region of the buffer depending on an environment in which a user uses a system which includes the storage apparatus and the host apparatus, and it is possible to suppress a corresponding increase in the amount of data to be processed within the storage apparatus.

According to one aspect of the present invention, it is possible to provide a buffer control method and a storage apparatus which can suppress the performance deterioration of the storage apparatus at the time of the sequential access.

A description will now be given of the buffer control method and the storage apparatus in each embodiment of the present invention, by referring to the drawings.

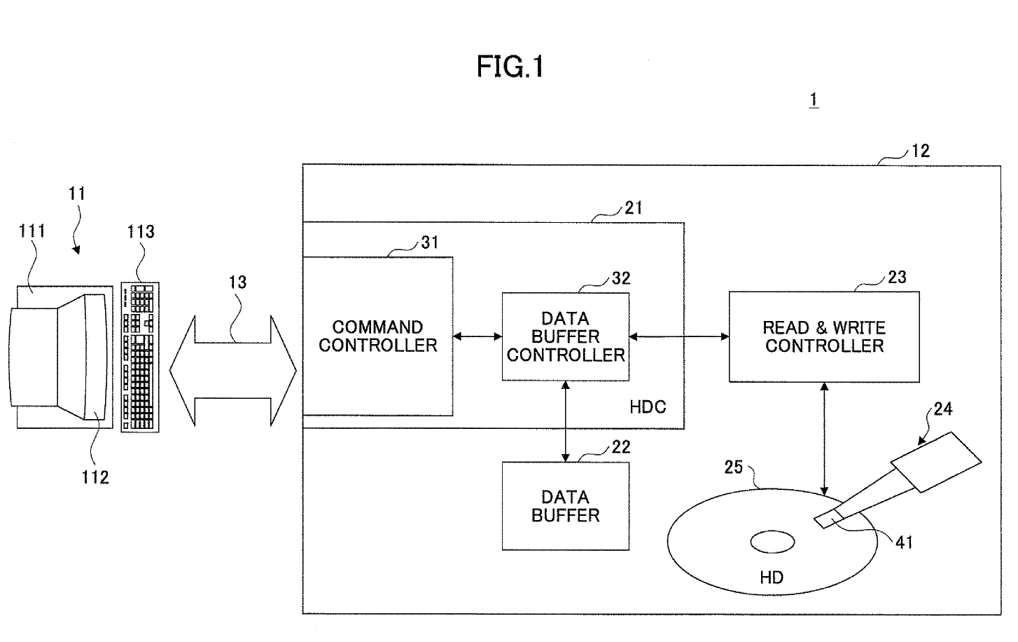

FIG. 1 is a diagram illustrating a system in an embodiment of the present invention. In a system 1 illustrated in FIG. 1, a host apparatus 11 and a storage apparatus 12 are connected via a cable and/or a radio (or wireless) interface 13. For example, the system 1 forms a data processing system, a storage system or the like.

For example, the host apparatus 11 is formed by a general-purpose computer having a known structure. In this embodiment, the host apparatus 11 includes a main body 111, a display part 112, and a keyboard 113. The main body 111 includes a processor such as a central processing unit (CPU) and a storage part.

In this embodiment, the storage apparatus 12 is formed by a magnetic disk drive having a known structure. The storage apparatus 12 includes a hard disk controller (HDC) 21, a data buffer 22, a read and write controller 23, an actuator 24, a magnetic disk 25 and the like which are connected as illustrated in FIG. 1. The HDC 21 includes a command controller 31 and a data buffer controller 32. The actuator 24 includes a magnetic head 41 which write data on the magnetic disk 25 and reads data from the magnetic disk 25.

Of course, the storage apparatus 12 is not limited to the magnetic disk drive, and a recording medium used by the storage apparatus 12 is not limited to a magnetic recording medium such as the magnetic disk 25. For example, it is possible to use a recording medium such as an optical recording medium, including an optical disk, and a magneto-optical recording medium, including a magneto-optical disk.

The command controller 31 performs a command receiving process for receiving a command from the host apparatus 11, a cache control process and the like. The data buffer controller 32 performs a control to store data transferred from the host apparatus 11 and the magnetic disk 25 in the data buffer 22, and to transfer data stored in the data buffer 22 to the host apparatus 11 and the magnetic disk 25. The read and write controller 23 includes a read and write channel and the like, and controls the magnetic disk 25 and the actuator 24.

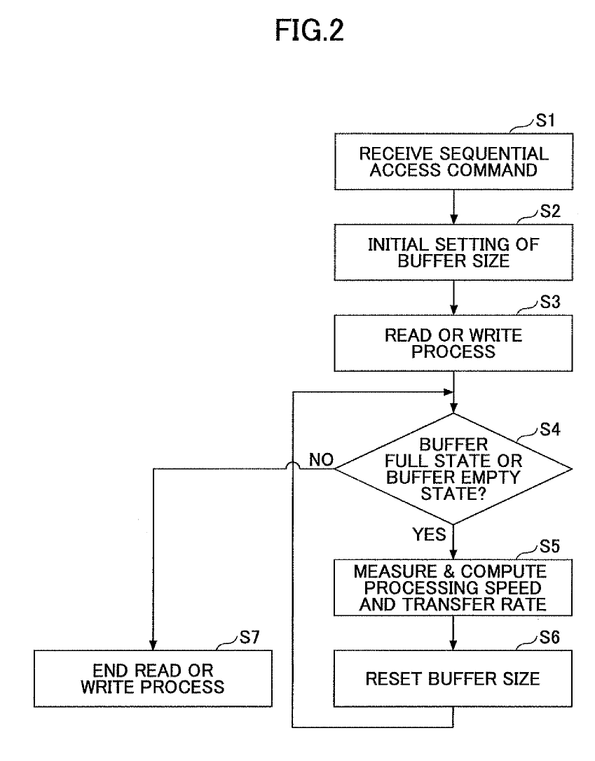

FIG. 2 is a flow chart for explaining an operation of this embodiment. Each step (or procedure) of the process illustrated in FIG. 2 corresponds to each step of the buffer control method of this embodiment. In FIG. 2, steps S1, S2 and S4 through S6 are executed by the HDC 21, and steps S4 and S7 are executed by the read and write controller 23.

In the step S2 illustrated in FIG. 2, the command controller 31 receives a sequential access command issued from the host apparatus 11. In the step S2, the data buffer controller 32 initially sets a storage region of the data buffer 22 to a size which is small compared to a maximum size.

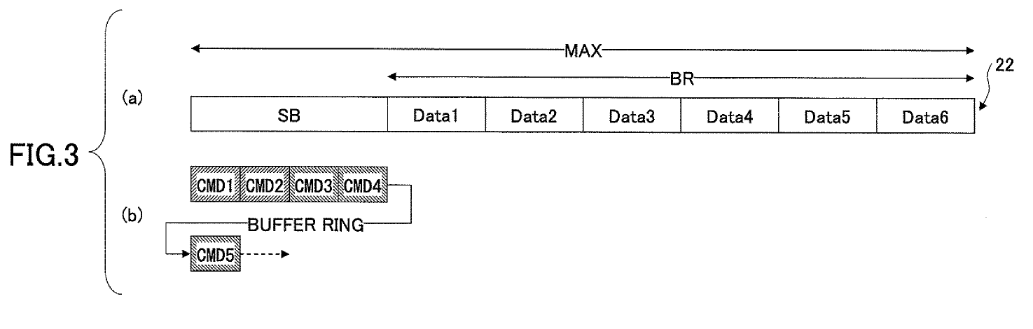

FIG. 3 is a diagram for explaining an initial setting of the size of the storage region in the data buffer 22 performed by the step S2. In FIG. 3, SB denotes a storage region that is used as a sequential buffer in the data buffer 22, BR denotes other storage regions for storing other data Data1, . . . , Data6 and the like in the data buffer 22, and MAX denotes a maximum size of the storage region of the data buffer 22. The storage region SB is used as a buffer ring. CMD1, . . . , CMD5 denote data stored in the storage region SB or, data read from the storage region SB. In FIG. 3 and FIGS. 4 through 6 which will be described later, a leftwardly descending hatching denotes write data already written on the magnetic disk 25 via the storage region SB if the sequential access command is a sequential write command, and read data already transferred to the host apparatus 11 via the storage region SB if the sequential access command is a sequential read command. On the other hand, a rightwardly descending hatching denotes write data not yet written on the magnetic disk 25 via the storage region SB if the sequential access command is the sequential write command, and read data not yet transferred to the host apparatus 11 via the storage region SB if the sequential access command is the sequential read command. In FIGS. 3 through 6, (a) illustrates the storage region of the data buffer 22, and (b) illustrates a state where the data buffer 22 is used as the buffer ring.

In the step S3 illustrated in FIG. 2, the read and write controller 23 executes an access process depending on the sequential access command. If the sequential access command is the sequential write command, the read and write controller 23 stores the write data transferred from the host apparatus 11 to the storage region SB in the data buffer 22, and writes the write data stored in the storage region SB on the magnetic disk 25 by the magnetic head 41. On the other hand, if the sequential access command is the sequential read command, the read and write controller 23 stores the read data read from the magnetic disk 25 by the magnetic head 41 to the storage region SB in the data buffer 22, and transfers the read data stored in the storage region SB to the host apparatus 11.

When initially setting the size of the storage region SB, the storage region SB is set to the size which is small compared to the maximum size MAX of the storage region of the data buffer 22, based on the sequential access command. For this reason, when a buffer full state or a buffer empty state occurs in the data buffer 22, a waiting of the rotation of the magnetic disk 25 is generated. When the waiting of the rotation of the magnetic disk 25 is generated, the rotation of the magnetic disk 25 is maintained until it becomes possible to perform a process in units of the data transfer via the storage region SB in the data buffer 22, but the storage apparatus 12 assumed a waiting state. The buffer full state refers to a state where there is data to be stored in the data buffer 22, such as the read data read from the magnetic disk 25, but an unused storage region SB in the data buffer 22 is insufficient or there is no unused storage region SB in the data buffer 22. On the other hand, the buffer empty state refers to a state where there is no data to be read from the storage region SB in the data buffer 22, such as the write data to be written on the magnetic disk 25.

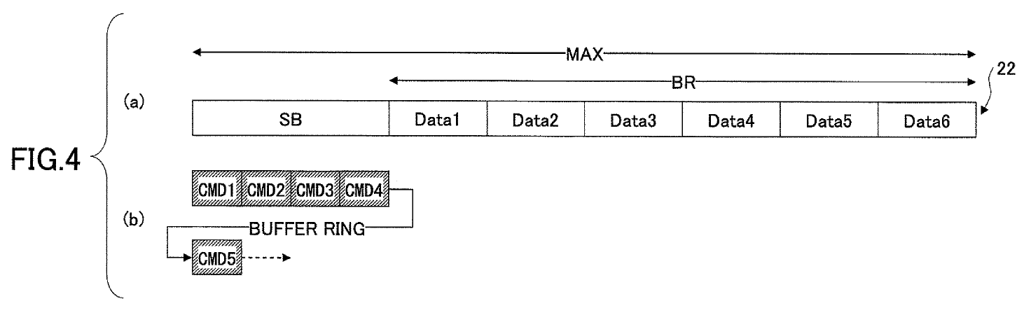

FIG. 4 is a diagram for explaining a state where the waiting of the rotation of the magnetic disk 25 is generated in the storage apparatus 12. In FIG. 4, those parts which are the same as those corresponding parts in FIG. 3 are designated by the same reference numerals, and a description thereof will be omitted. In FIG. 4(b), if the sequential access command is the sequential write command, the write data to be stored on the magnetic disk 25 via the storage region SB is not stored in the storage region SB, and in this case, the buffer empty state is generated. On the other hand, if the sequential access command is the sequential read command, the read data to be read from the magnetic disk 25 and transferred to the host apparatus 11 via the storage region SB cannot be stored in the storage region SB, because the storage region SB having a size sufficient to store the read data cannot be secured, and in this case, the buffer full state is generated.

In the step S4 illustrated in FIG. 2, the data buffer controller 32 decides (or judges) whether the buffer full state or the buffer empty state is generated. The size of the storage region SB in the data buffer 22 and the unit of the data transfer to the magnetic disk 25 or the host apparatus 11 via the data buffer 22 are known in advance. Hence, the step S4 can decide, by a known method, whether the buffer full state or the buffer empty state is generated. The process advances to the step S5 if the decision (or judgement) result in the step S4 is YES, and the process advances to the step S7 which will be described later if the decision result in the step S4 is NO.

In the step S5 illustrated in FIG. 2, the command controller 31 measures, by a known method, a number of sectors and a data transfer rate of the magnetic disk 25 requested by the sequential access command issued from the host apparatus 11, an issuing interval of the commands, and an internal processing time from a time when the command from the host apparatus 11 is received to a time when the data transfer starts within the storage apparatus 12, during the waiting of the rotation of the magnetic disk 25. For example, the data transfer starts within the storage apparatus 12 when the transfer of the write data from the data buffer 22 to the magnetic disk 25 starts or, when the transfer of the read data from the magnetic disk 25 to the data buffer 22 starts. The step S5 also computes the data processing speed of the host apparatus 11 and the data transfer rate of the magnetic disk 25 within the storage apparatus 12, based on the measured results. The data transfer rate of the magnetic disk 25 refers to the data transfer rate between the magnetic disk 25 and the data buffer 22. The data processing speed of the host apparatus 11 and the data transfer rate of the magnetic disk 25 may be computed based on the following formulas, for example, where WBS denotes the size of the storage region SB in the data buffer 22 at a time when the sequential write process is executed, RBS denotes the size of the storage region SB in the data buffer 22 at a time when the sequential read process is executed, DPS denotes the data processing speed of the host apparatus 11, DTS denotes the data transfer rate of the magnetic disk 25, DRT denotes a time required for the magnetic disk 25 to make one revolution (also referred to as one revolution time), and * denotes a multiplication.

WBS=DPS*DRT

RBS=DTS*DRT

In the step S6 illustrated in FIG. 2, the data buffer controller 32 resets the size of the storage region SB in the data buffer 22 within the storage apparatus 12 by enlarging or reducing the size of the storage region SB to a limit size which does not generate the buffer full state or the buffer empty state during the waiting of the rotation of the magnetic disk 25, using the computed results obtained in the step S5.

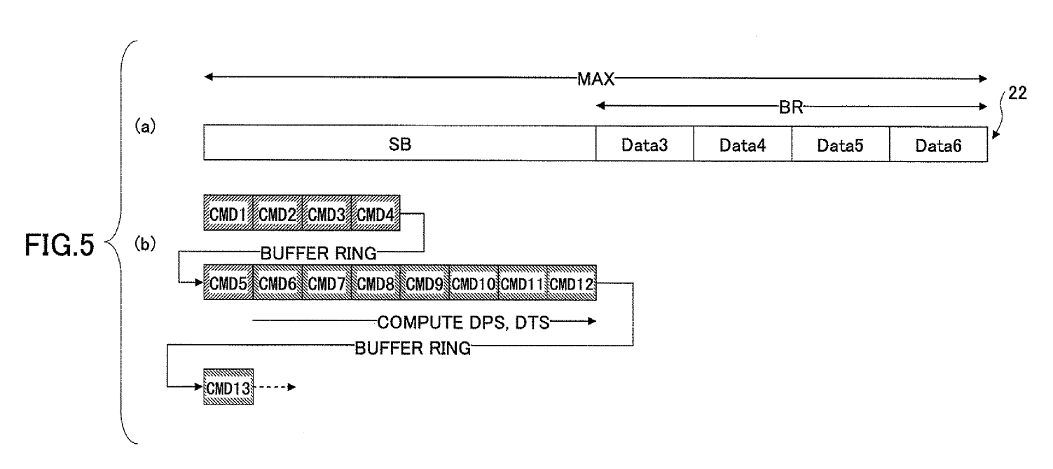

FIG. 5 is a diagram for explaining the resetting of the size of the storage region SB in the data buffer 22 by the step S6. In FIG. 5, those parts that are the same as those corresponding parts in FIG. 3 are designated by the same reference numerals, and a description thereof will be omitted.

In FIG. 5(b), if the sequential access command is the sequential write command, the storage region SB does not store the write data to be written on the magnetic disk 25 via the storage region SB, and in this case, the buffer empty state is generated. On the other hand, if the sequential access command is the sequential read command, the read data to be read from the magnetic disk 25 and transferred to the host apparatus 11 via the storage region SB cannot be stored in the storage region SB, because the storage region SB having a size sufficient to store the read data cannot be secured, and in this case, the buffer full state is generated.

After the step S6, the process returns to the step S4, and the processes of the steps S4 through S6 are repeated until the decision result in the step S4 becomes NO. Such processes are performed during the waiting of the rotation of the magnetic disk 25 in the storage apparatus 12, until the buffer full state or the buffer empty state is generated. Hence, the storage apparatus 12 seldom assumes a state where a command end response cannot be made with respect to the command from the host apparatus 11, and there is hardly any disadvantage of causing the waiting of the rotation of the magnetic disk 25 by setting the storage region SB in the data buffer 22 to a small region by the initial setting.

If the decision result in the step S4 is NO, the read and write controller 23 ends the access process according to the sequential access command, that is, ends the sequential write process or the sequential read process, in the step S7.

Next, a description will be given of a particular example when executing the sequential write command. For example, if the number of sectors of one command is 64 sectors, the data transfer rate is 130 MB/s, the issuing interval of the commands is 0.0003 s, and the internal processing time from the reception of the command to the start of the data transfer is 0.0002 s, the data processing speed of the host apparatus 11 becomes 43.5 MB/s. In addition, for the sake of convenience, it is assumed that the one revolution time of the magnetic disk 25 is 0.0111 s, and the data transfer rate of the magnetic disk 25 is 50 MB/s.

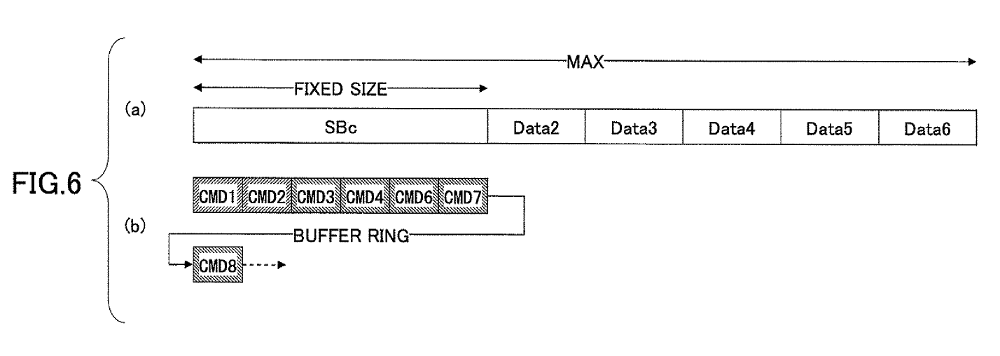

When a conventional technique is employed, the size of a storage region SBc of the data buffer is fixed to 0.4 MB, for example, as illustrated in FIG. 6. FIG. 6 is a diagram for explaining the state where the waiting of the rotation of the magnetic disk is generated in the storage apparatus in the case where the conventional technique is employed. In this case, the buffer empty state is generated once in every approximately 0.062 s, and the waiting of the rotation of the magnetic disk is generated in the storage apparatus. If the data is received at the data processing speed of the host apparatus by the data buffer having a size of 0.4 MB during the waiting of the rotation of the magnetic disk, the buffer full state is generated in 0.0092 s. Hence, during a time of 0.0019 s (=0.0111 s−0.0092 s) until the storage apparatus can execute the data write to the magnetic disk, the storage apparatus cannot make a command end response to the host apparatus, and the performance of the storage apparatus deteriorates.

On the other hand, when the technique of this embodiment is employed, a small range (or region) of the data buffer 22 is initially secured as the storage region SB (or the region of the sequential buffer). Because the maximum data transfer rate of the host apparatus 11 will positively become higher than the present data transfer rate of the magnetic disk 25 which is 50 MB/s, the waiting of the rotation of the magnetic disk 25 will not be generated in the storage apparatus 12 depending on the state of the data buffer 22. For this reason, no inconveniences will be introduced even if the size of the storage region SB (or the sequential buffer size) is set to a controllable minimum size, and the size of the storage region SB is set to 0.2 MB in this example. In the case where the host apparatus 11 has the data processing speed of 43.5 MB/s, the buffer empty state is generated once in every 0.031 s. During the waiting of the rotation of the magnetic disk 25 in the storage apparatus 12, the storage apparatus 12 measures the data processing speed of the host apparatus 11 as being 43.5 MB/s, and as described above in conjunction with FIG. 5, the size of the storage region SB in the data buffer 22 is enlarged from 0.2 MB to 0.483 MB (=43.5 MB/s*0.0111 s). By enlarging the size of the storage region SB in the data buffer 22 in this manner, the buffer full state will not be generated, and it is possible to prevent the performance deterioration of the storage apparatus 12.

In addition, compared to the case where the conventional technique is employed, the performance deterioration of the storage apparatus 12 can be prevented by simply increasing the size of the storage region SB in the data buffer 22 to 0.083 MB by employing the technique of this embodiment, and further, it is possible to hold useful cache data to a maximum.

Of course, the measuring timing in the step S5 is not limited to during the waiting of the rotation of the magnetic disk 25 in the storage apparatus 12, and the measurement may be made during the read process or the write process. Moreover, a number of sectors and a data transfer rate of the magnetic disk 25 requested by the sequential access command issued from the host apparatus 11, an issuing interval of the commands, and an internal processing time from a time when the command from the host apparatus 11 is received to a time when the data transfer starts within the storage apparatus 12 may be measured in the case of the read process, similarly to the case of the write process, the difference being only the buffer full state or the buffer empty state.

In the embodiment described above, the size of the storage region SB of the data buffer (or the sequential buffer size) is determined by monitoring the data processing speed of the host apparatus. Hence, it is possible to set the sequential buffer size to more suit the performance and the like of the host apparatus when compared to the conventional technique. Therefore, it is possible to simultaneously hold the data already stored in the data buffer and reduce the generation of the buffer full state or the buffer empty state, and to efficiently improve the performance of the storage apparatus. In addition, it is unnecessary to tune the sequential buffer size depending on an environment in which the user uses the system which includes the storage apparatus and the host apparatus, and it is possible to suppress a corresponding increase in the amount of data to be processed within the storage apparatus.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A buffer control method comprising:
storing data to be written on a recording medium or data read from the recording medium to consecutive addresses within a storage region of a buffer, based on a sequential access command which instructs a continuous access to consecutive logical addresses of the recording medium;
variably setting a size of the storage region of the buffer depending on an unused region or a used region in the storage region of the buffer; and
using the buffer as a buffer ring.

2. The buffer control method as claimed in claim 1, wherein the variably setting includes:
judging whether the buffer is in a first state where the unused region of the storage region is insufficient to store the data or, a second state where the data to be read is not stored in the used region of the storage region of the buffer;
computing a data processing speed of a host apparatus which issues the sequential access command and a data transfer rate of the recording medium, when the judging judges that the buffer is in the first or second state; and
resetting the size of the storage region of the buffer based on the data processing speed and the data transfer rate that are computed.

3. The buffer control method as claimed in claim 2, wherein the resetting increases the size of the storage region of the buffer depending on a decrease in the data processing speed of the host apparatus caused by a state of the storage apparatus which includes the recording medium and the buffer.

4. The buffer control method as claimed in claim 2, wherein the resetting resets the size of the storage region of the buffer based on the data processing speed of the host apparatus when the sequential access command is a sequential write command, and resets the size of the storage region of the buffer based on the data transfer rate of the recording medium when the sequential access command is a sequential read command.

5. The buffer control method as claimed in claim 2, further comprising:
initially setting the storage region of the buffer to a size which is small compared to a maximum size, based on the sequential access command.

6. A storage apparatus comprising:
a recording medium;
a buffer; and
a controller configured to perform a control to store data to be written on the recording medium or data read from the recording medium to consecutive addresses within a storage region of the buffer, based on a sequential access command which instructs a continuous access to consecutive logical addresses of the recording medium,
wherein the controller variably sets a size of the storage region of the buffer depending on an unused region or a used region in the storage region of the buffer, and the buffer is used as a buffer ring.

7. The storage apparatus as claimed in claim 6, wherein the controller comprises:
a data buffer controller configured to judge whether the buffer is in a first state where the unused region of the storage region is insufficient to store the data or, a second state where the data to be read is not stored in the used region of the storage region of the buffer; and
a command controller configured to compute a data processing speed of a host apparatus which issues the sequential access command and a data transfer rate of the recording medium, when the data buffer controller judges that the buffer is in the first or second state,
wherein the data buffer controller resets the size of the storage region of the buffer based on the data processing speed and the data transfer rate that are computed by the command controller.

8. The storage apparatus as claimed in claim 7, wherein the data buffer controller increases the size of the storage region of the buffer depending on a decrease in the data processing speed of the host apparatus caused by a state of the storage apparatus which includes the recording medium and the buffer.

9. The storage apparatus as claimed in claim 7, wherein the data buffer controller resets the size of the storage region of the buffer based on the data processing speed of the host apparatus when the sequential access command is a sequential write command, and resets the size of the storage region of the buffer based on the data transfer rate of the recording medium when the sequential access command is a sequential read command.

10. The storage apparatus as claimed in claim 7, wherein the data buffer controller initially sets the storage region of the buffer to a size which is small compared to a maximum size, based on the sequential access command.

11. The storage apparatus as claimed in claimed in claim 7, wherein the command controller judges whether the buffer is in the first state when the sequential access command is a sequential write command, and judges whether the buffer is in the second state when the sequential access command is a sequential read command.

12. The storage apparatus as claimed in claim 6, wherein:
the recording medium includes a disk; and
waiting of a rotation of the disk is generated in the first or second state.
